(19) United States
(12) Patent Application Publication
(10) Pub. No.: US 2025/0355962 A1
(43) Pub. Date: Nov. 20, 2025

(54) SOLVER AND METHOD FOR SOLVING CONTINUOUS-OPTIMIZATION PROBLEMS

(71) Applicant: Zapata Computing, Inc., Boston, MA (US)

(72) Inventors: Vladimir Vargas Calderón, Bogotá (CO); Yudong Cao, Cambridge, MA (US); Alejandro Perdomo Ortiz, Toronto (CA)

(21) Appl. No.: 18/596,023

(22) Filed: Mar. 5, 2024

Related U.S. Application Data
(60) Provisional application No. 63/450,153, filed on Mar. 6, 2023.

(51) Int. Cl. G06F 17/11; G06N 10/60

(52) U.S. Cl. CPC G06F 17/11; G06N 10/60

(57) ABSTRACT

A method for solving a continuous optimization problem includes: (1) Training a generative model using a training data set. (2) Generating, using the model, a configuration-pool including candidate solutions, for minimizing the optimization problem's cost function, which include evaluated candidate solutions and non-evaluated candidate solutions. (3) Generating a refined configuration-pool that includes qualified candidates, of the candidate solutions, using a refinement method and candidate solutions of a previous configuration-pool. (4) Determining, from the evaluated candidate solutions, a best candidate solution that yields the lowest cost. (5) Generating new cost values by evaluating the cost function of selected non-evaluated candidate solutions of candidate solutions. New cost values include cost values of selected evaluated candidate solutions of the candidate solutions. When a new cost value is less than the cost value of the best candidate solution, the best candidate solution is replaced with the candidate solution that yields the new cost value.

### BACKGROUND

Quantum computers promise to solve industry-critical problems which are otherwise unsolvable or only very inefficiently addressable using classical computers. Key application areas include chemistry and materials, bioscience and bioinformatics, logistics, and finance. Interest in quantum computing has recently surged, in part due to a wave of advances in the performance of ready-to-use quantum computers.

### SUMMARY OF THE EMBODIMENTS

A method for solving a continuous optimization problem includes: training a generative model using a training data set; and generating, using the generative model, a configuration-pool including a plurality of candidate solutions for minimizing the optimization problem's cost function. The plurality of candidate solutions includes both (a) evaluated candidate solutions and (b) non-evaluated candidate solutions. The cost value of the cost function of each evaluated candidate solution is stored in a memory accessible by a device executing the method. The method also includes generating a refined configuration-pool that includes qualified candidates, of the plurality of the candidate solutions, using a refinement method and candidate solutions of a previous configuration-pool generated using the generative model. The method also includes determining, from the evaluated candidate solutions of the qualified candidates, a best candidate solution that yields the lowest cost. The method also includes generating a plurality of new cost values by evaluating the cost function of selected non-evaluated candidate solutions of the plurality of candidate solutions. The plurality of new cost values further includes cost values of selected evaluated candidate solutions of the plurality of candidate solutions. When a new cost value of the plurality of new cost values is less than the cost value of the best candidate solution, the method includes replacing the best candidate solution with the selected evaluated candidate solution that yields the new cost value.

### BRIEF DESCRIPTION OF THE FIGURES

FIG. 1 is a diagram of a quantum computer according to an embodiment.

FIG. 2A is a flowchart of a method performed by the quantum computer of FIG. 1 according to an embodiment.

FIG. 2B is a diagram of a hybrid quantum-classical computer which performs quantum annealing according to an embodiment.

FIG. 3 is a diagram of a hybrid quantum-classical computer according to an embodiment.

FIG. 4 is a schematic of an embodiment of a solver, which may include one or more elements of the hybrid quantum-classical computer of FIG. 3.

FIG. 5 is a flowchart illustrating a method for solving a continuous optimization problem which may be implemented by the solver of FIG. 4, according to an embodiment.

### DETAILED DESCRIPTION OF THE EMBODIMENTS

### 1. Quantum Computers and Hybrid Quantum-Classical Quantum Computers

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, when electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred to as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2n×2n complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled E). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

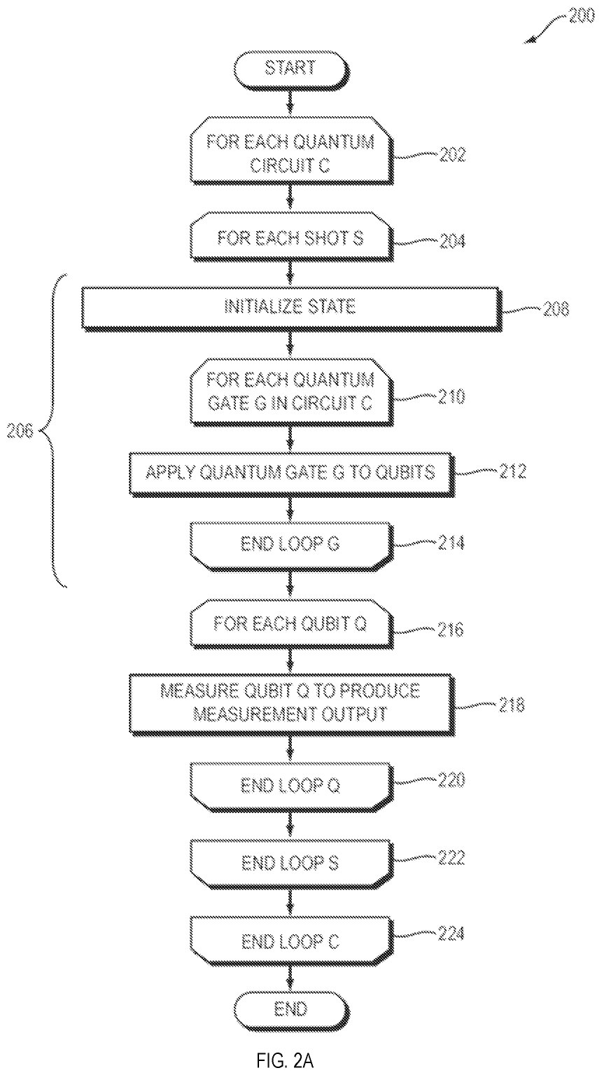

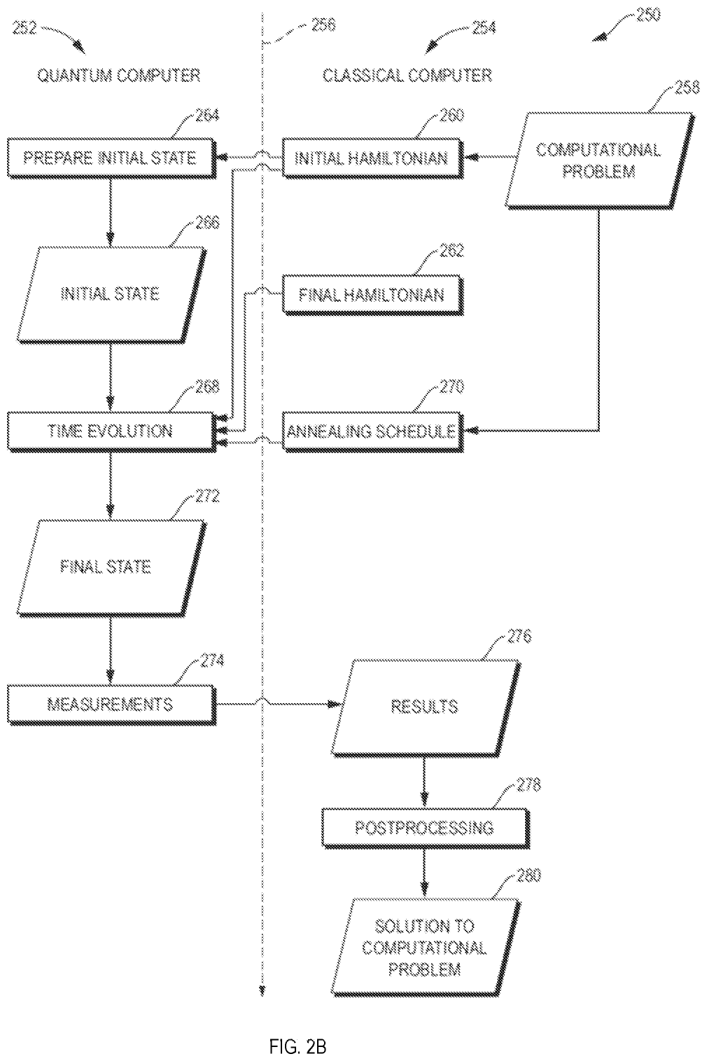

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. When the rate of change of the system Hamiltonian is slow enough, the system stays close to the ground state of the instantaneous Hamiltonian. When the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original computational problem 258. An experimental demonstration of the success of quantum annealing for random magnets was reported immediately after the initial theoretical proposal.

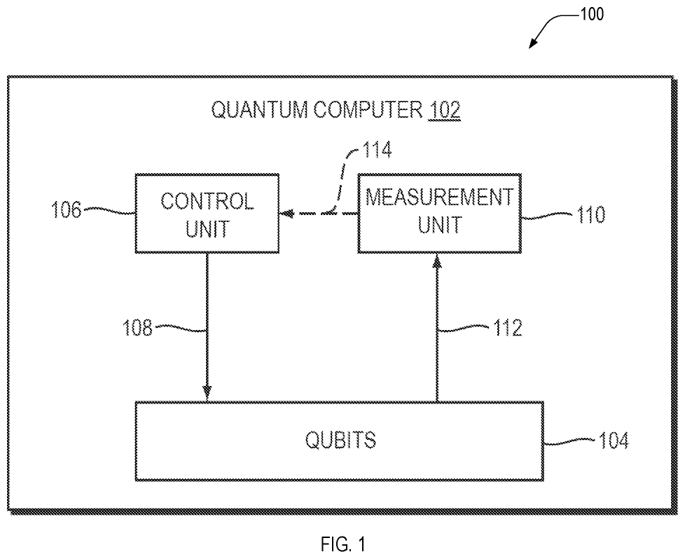

The final state 272 of the quantum computer 252 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to an embodiment. Referring to FIG. 2A, a flowchart is shown of a method 200 performed by the system 100 of FIG. 1 according to an embodiment. The system 100 includes a quantum computer 102. The quantum computer 102 includes a plurality of qubits 104, which may be implemented in any of the ways disclosed herein. There may be any number of qubits 104 in the quantum computer 102. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:

In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.

In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.

In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.

In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.

In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.

In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.

In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.

In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback signals 114 from the measurement unit 110 to the control unit 106. Such feedback signals 114 are also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e., the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

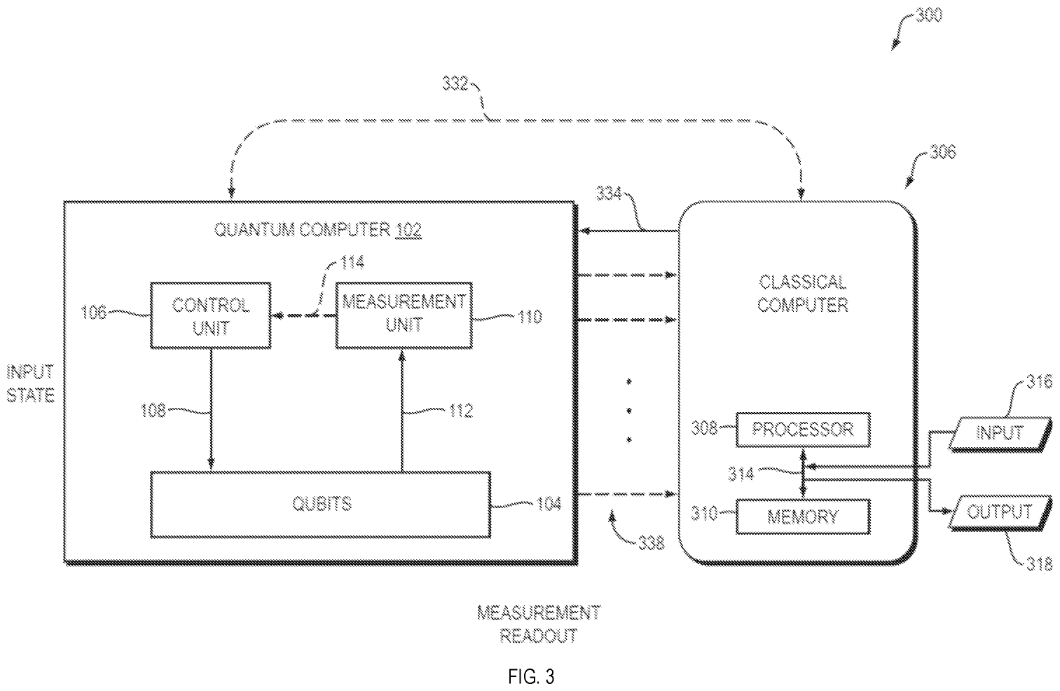

Referring to FIG. 3, a diagram is shown of a hybrid quantum classical (HQC) computer 300 implemented according to an embodiment. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals 332 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals 334 to the quantum computer 102, in response to which the quantum computer 102 may apply the gate operations specified by the control signals 332 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output 338 representing the collapse of the states of the qubits 104 into one of their eigenstates. As a result, the measurement output 338 includes or consists of bits and therefore represents a classical state. The quantum computer 102 provides the measurement output 338 to the classical processor 308. The classical processor 308 may store data representing the measurement output 338 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

### 2. Continuous Generator-Enhanced Optimization (cGEO)

Recently, the Generator-Enhanced optimization (GEO) framework has been proposed to solve combinatorial optimization problems, leveraging classical, quantum, quantum-inspired or hybrid generative models to generate solutions to such problems. Embodiments disclosed herein we extend the domain of GEO to continuous variables (cGEO), broadening its application to a more general spectrum of optimization problems that arise in science and the industry. Crucially, cGEO excels at generating low-cost candidate solutions when the number of cost function evaluations is limited due to expensive computational cost. Embodiments utilize local optimization routines, including gradient-based optimizers, to exploit the cost function. cGEO may act as a cost landscape exploration mechanism that serves as a computationally cheap initialization strategy for minimizing a cost function through a local optimizer. For example, cGEO may narrow the scope of candidate solutions that the local optimizer explores, and may find regions within the solution space for the local optimizer to explore.

### 2.1 Methods

Continuous generative enhanced optimization (cGEO) is a framework that generalizes GEO—which was originally proposed to solve optimization problems in the binary space—to the continuous domain. In summary, GEO iteratively uses a generative model to propose candidate solutions of an optimization problem that aims to minimize a cost function defined in a binary solution space. In what follows, we explain in detail the cGEO algorithm.

Consider a cost function C: [symbol] ⊂ [symbol] → [symbol] that maps n-dimensional configurations x∈ [symbol] into a cost value C(x). The set [symbol] is called the solution space and it is a compact set. Its elements are referred to as (candidate) solutions, data points, or configurations. The problem that cGEO solves is

$${min}_{x ∈ 𝕏} C ( x ) , \qquad ( 1 )$$

subject to some given set of constraints. In embodiments, x is a vector having n elements, at least one of which is a continuous variable.

### 2.1.1 Initialization

cGEO uses access to an initial pool of configurations [symbol] ₀⊂ [symbol] , which, at worst, can be generated randomly. Here, the letter [symbol] stands for “pool.” To best illustrate the method, we start with a subset of these configurations [symbol] ₀⊆ [symbol] ₀ having known or observed cost function values; we denote by [symbol] ₀= [symbol] ₀\ [symbol] ₀. The letter [symbol] stands for “observed” and [symbol] for “non-observed,” referring to whether the cost function of their members has been observed or not, respectively. Embodiments disclosed herein use both subscripts 0 and 1 subscripts t and t+1, where time step t is a non-negative integer. Instances subscript 0 and subscript t are interchangeable, as are subscripts 1 and t+1. subscripts 0 and 1 are equivalent to subscripts t and t+1 respectively, where time step t is set to zero. For example [symbol] ₀ is identical to [symbol] ₜ, while [symbol] ₁ is identical to [symbol] ₜ₊₁.

We use “knowing the cost value of a configuration” and “observing a configuration” synonymously. From the observed configuration set and the initial pool of configurations we construct a data set

$${\tilde{𝒟}}_{0} = \{ ( x , C ( x ) ) \vert x ∈ {𝕆}_{0} \} ⋃ \{ ( x , {max}_{{x}^{′} ∈ {𝕆}_{0}} C ( {x}^{′} ) ) \vert x ∈ {\check{𝕆}}_{0} \} , \qquad ( 2 )$$

that is: take the pairs of configurations and their corresponding costs and add to that set pairs of configurations with unknown costs accompanied by the maximum known cost.

### 2.1.2 The Generative Model

The data set [symbol] ₀ is now transformed into a surrogate probability density data set [symbol] ₀ that can be used to train a generative model. The general idea behind using a transformed version of [symbol] ₀ to train a generative model is that configurations with high-cost values should be seen as low-probability density points by the generative model. Similarly, low-cost values should be seen as high-probability density points. Thus, after training, the generative model should be able to generate (with high probability) configurations whose cost values are likely to be low.

More explicitly, we build the training data set as [symbol] ₀={(x, f(y, [symbol] ₀)), |(x,y)∈ [symbol] ₀}, where f maps cost values into probability densities. For illustration, we use the Boltzmann distribution to map cost values into probability densities: f(y, [symbol] ₀)= [symbol] exp(−βy), where [symbol] is a normalization constant of the induced distribution.

The function f induces a unique probability density function q₀ through

$${q}_{0} ( x ) = f ( C ( x ) , {\tilde{𝒟}}_{𝕏} ) = {[ {\int }_{𝕏} d x {e}^{- β C ( x )} ]}^{- 1} {e}^{- β C ( x )} \qquad ( 3 )$$

where [symbol] ={(x, C(x))|x∈ [symbol] } is the configuration-cost data set of the whole solution space. Using only the data set [symbol] ₀ will induce an estimation \hat{q}₀ of probability density function q₀. The job of the generative model is to learn this probability density function estimation in the whole solution space [symbol] to iteratively update the data set [symbol] ₜ at time step t so that estimation \hat{q}ₜ better approximates probability density function q₀. To do so, the generative model is first trained with the data set [symbol] ₀.

### 2.1.2a Probability Density Versus Spatial Density

In general, points in [symbol] ₀ may not be distributed according to probability density function q₀. Instead, let them be distributed according to estimation \hat{q}₀. This poses a potential difficulty: a region A of the solution space [symbol] might contain the large majority of configurations in the pool [symbol] ₀ o with high costs, whereas another region B of [symbol] might contain just a few of the configurations in [symbol] ₀ with low cost. In this case, the induced \hat{q}₀ is small in region A and large in region B. Regardless, the probability accumulated in region A can be higher than the probability accumulated in region B by virtue of spatial density: there are more points of [symbol] ₀ that are present in region A, despite their probability density being lower than that of points in region B.

When no prior knowledge of the cost function allows us to construct a well-behaved initial pool of configurations [symbol] ₀, meaning that the configurations x∈ [symbol] ₀ are approximately distributed by q₀, we can always construct [symbol] ₀ distributed according to a uniform distribution over [symbol] , almost surely avoiding the situation of having the regions A and B described before.

### 2.1.2b Training of the Generative Model

After optionally ensuring that [symbol] ₀ will not present the A-B region situation, we train the generative model. Training a generative model generally includes computing a loss function that looks like Σᵢ [symbol] (xᵢ), where the subscript i indexes the training data set, and [symbol] is a loss function. Since, in our case, data is not necessarily distributed according to the induced probability density q₀, we weight the loss terms as

$$L ( {𝒟}_{0} ) = {\sum }_{( x , p ) ∈ {𝒟}_{0}} p ℓ ( x ) . \qquad ( 4 )$$

This ensures that the generative model learns from the probability density function \hat{q}₀(x)=p.

### 2.2 Generation of a New Pool of Configurations

After training, we can generate a new set of configurations [symbol] ₁ with the generative model. When the optimization problem requires it, we can filter out configurations that do not satisfy a given set of constraints. Note that the initial state of knowledge of the cost function might lead the generative model to generate configurations that reproduce the A-B region situation. To avoid this, and to control the usual exploitation-exploration trade-off in the optimization domain, we implement configuration post-selection.

### 2.2.1 The Selector

The refinement of the set of generated configurations [symbol] ₁ is carried out in the following way. We emphasize that this is just one way of refining [symbol] ₁, meaning that we can replace this post-selection algorithm with any other.

Assume that configurations x∈ [symbol] ₁ have been filtered so that all of them satisfy the problem's constraints. Let r be a positive real number. We construct the set of valid generated configurations as [symbol] ₁={x|x∈ [symbol] ₁Λ [symbol] |x−x′|>r}, hereinafter equation (5). In other words, the valid generated configurations [symbol] ₁ will be the ones that are at least a distance r away from all the configurations in the previous state of the configuration pool [symbol] ₀. Thus, this candidate selection mechanism mitigates the A-B region issue.

Let N_{f} and N_{c} be fixed positive integers, and denote by x*∈ [symbol] ₀ the best observed configuration, i.e., the one with the lowest observed cost. Finally, we construct the new pool of configurations as [symbol] ₁= [symbol] ₁∪ [symbol] ₁, where

$${𝕆}_{1} = {𝕆}_{0} ⋃ {\overline{ℙ}}_{1}^{f} ⋃ {\overline{ℙ}}_{1}^{c} .$$

### Here

$${\overline{ℙ}}_{1}^{f}$$

is the set of N_{f} configurations in [symbol] ₁ farthest away from x*,

$${\overline{ℙ}}_{1}^{c}$$

is the set of N_{c} configurations in [symbol] ₁ closest to x* and [symbol] ₁⊂ [symbol] ₀ is a reduced subset of unobserved configurations, where N_{f}+N_{c} configurations from [symbol] ₀ are randomly removed, when possible.

Including configurations that are far away from the best known configuration foments exploration of the solution space [symbol] whereas including configurations that are close to the best known configuration foments exploitation.

### 2.3 Overall Algorithm

With these elements, it is possible to describe an embodiment of cGEO as an iterative algorithm, where each iteration includes the following steps:
1. Start from a set of observed configurations [symbol] ₜ and unobserved configurations [symbol] ₜ, from which a training data set [symbol] ₜ can be built.
2. Train a generative model using the training data set [symbol] ₜ.
3. Generate a set of configurations [symbol] ₜ₊₁, filtering out configurations that do not satisfy a given set of constraints.
4. Determine the set of valid generated configurations [symbol] ₜ₊₁⊆ [symbol] ₜ₊₁.
5. If | [symbol] ₜ₊₁|<N_{f}+N_{c}, generate N_{f}+N_{c}−| [symbol] ₜ₊₁| configurations uniformly distributed in [symbol] , and make the update r←r/2.
6. Create
a.

$${\overline{ℙ}}_{t + 1}^{f}$$

by selecting N_{f} configurations in [symbol] ₜ₊₁ farthest away from the best known configuration x*∈ [symbol] ₜ and
b.

$${\overline{ℙ}}_{t + 1}^{c}$$

by selecting N_{c} configurations in [symbol] ₜ₊₁ closest to the best known configurations x*∈ [symbol] ₜ.
7. Enlarge [symbol] ₜ by observing the configurations in

$${\overline{ℙ}}_{t + 1}^{f} and {\overline{ℙ}}_{t + 1}^{c} ,$$

thus forming

$${𝕆}_{t + 1} = {𝕆}_{t} ⋃ {\overline{ℙ}}_{t + 1}^{f} ⋃ {\overline{ℙ}}_{t + 1}^{c} .$$

8. Randomly remove min(N_{f}+N_{c},| [symbol] |) configurations from [symbol] ₜ to form [symbol] ₜ₊₁.

### 2.4 Solver

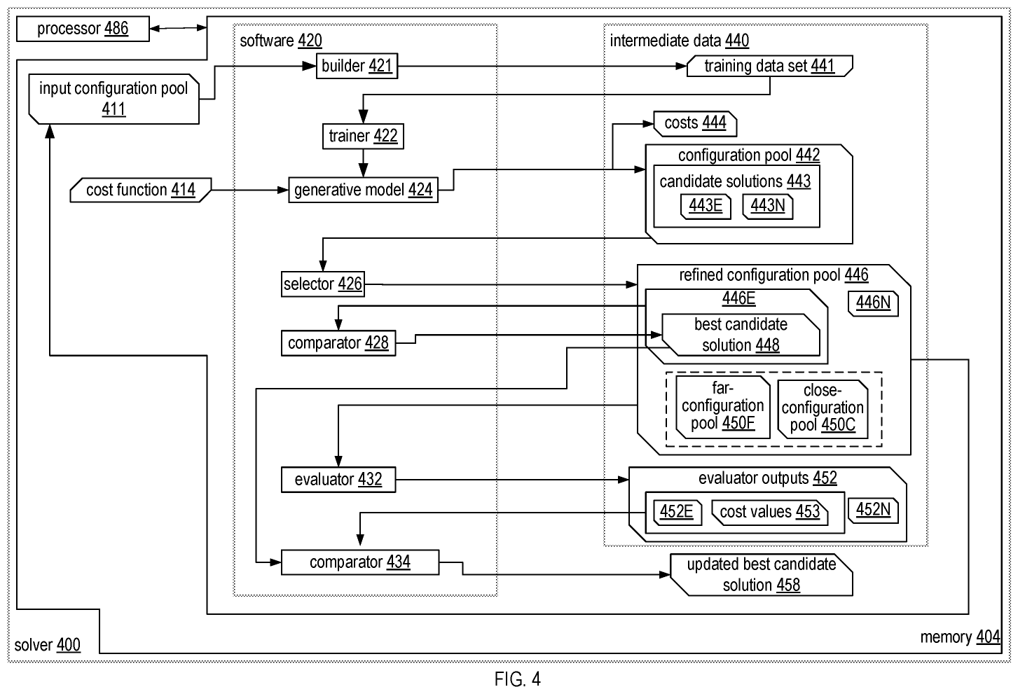

FIG. 4 is a schematic of a solver 400, which includes a processor 486 and a memory 404. Memory 404 stores non-transitory computer-readable instructions as software 420. When executed by processor 486, software 420 causes processor 486 to implement the functionality of solver 400 as described herein. Software 420 may be, or include, firmware. Solver 400 may include at least one of quantum computer 102 and classical computer component 306. For example, memory 404 may include memory 310 of computer 300, and processor 486 may include at least one of quantum computer 102 and processor 308. Processor 486 may include a quantum processor, such as a simulated annealing processor.

Memory 404 may be transitory and/or non-transitory and may include one or both of volatile memory (e.g., SRAM, DRAM, computational RAM, other volatile memory, or any combination thereof) and non-volatile memory (e.g., FLASH, ROM, magnetic media, optical media, other non-volatile memory, or any combination thereof). Part or all of memory 404 may be integrated into processor 486

Processor 486 may be any type of circuit or integrated circuit capable of performing logic, control, and input/output operations. For example, processor 486 may include one or more of a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC).

Software 420 includes at least one of a builder 421, a trainer 422, a generative model 424, a selector 426, a comparator 428, an evaluator 432, and a comparator 434. Builder 421 may implement eq. (2) to construct dataset [symbol] ₀ and/or training dataset [symbol] ₀. Trainer 422 may generate generative model 424 at least in part by implementing at least one of eq. (3) and eq. (4). Generative model 424 may be a generative model consistent with the generative model described in section 2.1.2.

Memory 404 stores an input configuration pool 411, a cost function 414, intermediate data 440, and an updated best candidate solution 448 of cost function 414. Solver 400 generates intermediate data 440 during processes for updated best candidate solution 448. In embodiments configuration pool 411 includes configurations [symbol] ₀ described in section 2.1.1. Aforementioned cost function C (section 2.1) is an example of cost function 414. Embodiments of solver 400 solve the cGEO problem of eq. (1).

Intermediate data 440 includes a training dataset 441, a configuration pool 442, a refined configuration pool 446, evaluator outputs 452. Training data set [symbol] ₀ is an example of training dataset 441. In embodiments, configuration pool 442 includes configurations [symbol] ₜ₊₁, and refined configuration pool 446 includes configurations [symbol] ₜ₊₁ discussed in sections 2.2.1 and 2.3.

Configuration pool 442 includes candidate solutions 443, which includes both (a) evaluated candidate solutions 443E and (b) non-evaluated candidate solutions 443N. Herein, an evaluated candidate solution is a candidate solution whose cost value is stored in a memory accessible by device 400. Accordingly, intermediate data 440 also includes cost values 444 of cost function 414 of each evaluated candidate solution 443E.

### 2.5 Method for Solving a Continuous Optimization Problem

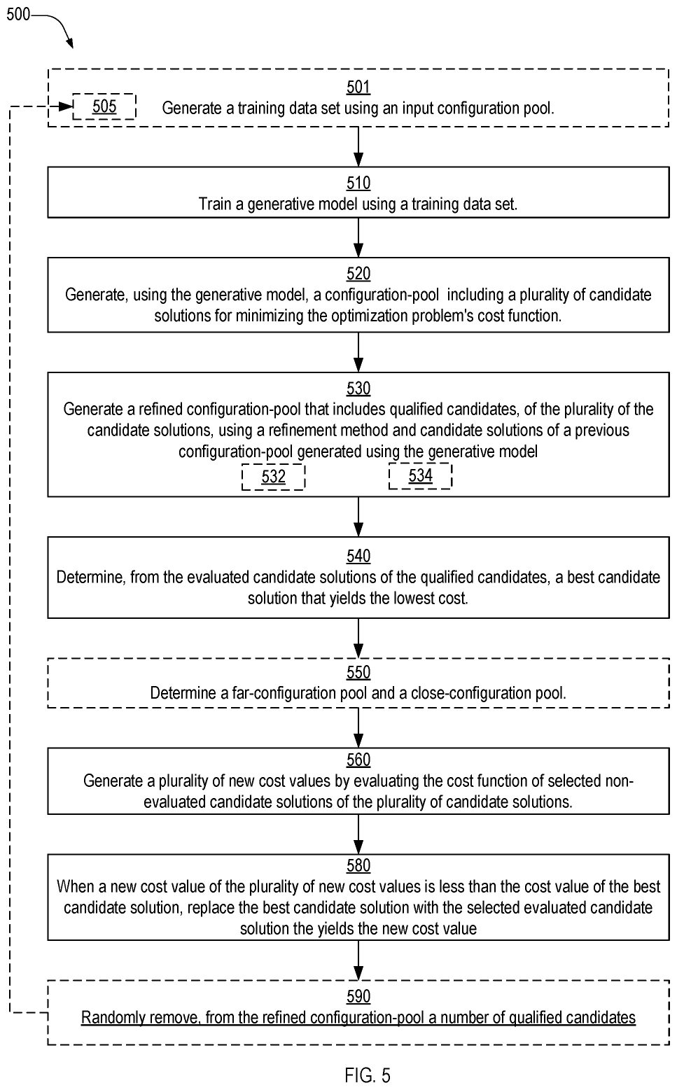

FIG. 5 is a flowchart illustrating a method 500 for solving a continuous optimization problem. The continuous optimization problem may be a problem encountered in one or more of many fields. Example fields include, but are not limited to, aerospace engineering, molecular dynamics and drug design, machine learning hyperparameter tuning, financial modeling, energy system optimization, automotive engineering, environmental modeling, and structural optimization.

Method 500 may be implemented by one or more aspects of solver 400. In certain embodiments, software 420 encodes method 500 as computer-readable instructions, and method 500 is implemented by processor 486 executing the computer-readable instructions of software 420. Method 500 includes at least one of steps 501, 510, 520, 530, 540, 560, and 580.

Step 501 includes generating a training data set using an input configuration-pool generated by a generative model. Examples of the training data set and input configuration-pool are training data set [symbol] ₜ and configuration-pool [symbol] ₜ of sections 2.1-2.3. In an example of step 501, builder 421 generates training data set 441 using input configuration-pool 411, that had been generated by generative model 424.

Step 510 includes training a generative model using a training data set. In an example of step 510, trainer 422 trains generative model 424 using training data set 441. Step 510 may also include producing generative model 424.

In embodiments, step 510 includes computing a weighted loss function that includes a sum of, for each of a plurality of initial candidate solutions for minimizing the cost function, products of a probability density function and a loss function evaluated at the initial candidate solution, where the cost function is an argument of the probability density function. Loss function [symbol] (x) and weighted loss function L( [symbol] ) of equation (4) are respective examples of the loss function and the weighted loss function.

Step 520 includes generating, using the generative model, a configuration-pool including a plurality of candidate solutions for minimizing the optimization problem's cost function. Configuration-pool [symbol] ₜ₊₁ is an example of the configuration pool of step 520. The plurality of candidate solutions includes both (a) evaluated candidate solutions and (b) non-evaluated candidate solutions, the cost value of the cost function of each evaluated candidate solution may be stored in a memory accessible by a device executing method 500. In example of step 520, generative model 424 generates configuration pool 442, which includes candidate solutions 443 described above.

Step 520 may include filtering out configurations that do not satisfy a predetermined constraint. Examples of constraints include requiring that the configuration corresponds to a physically realizable system and that each of its elements are within a desired range.

One or both of steps 510 and step 520 may be partly or entirely executed by quantum computer 102, as generative models produced and/or trained by quantum computers, as well as configuration pools, can be superior to those produced and/or trained by classical computers for certain optimization problems. See, for example, Hibat-Allah, M., Mauri, M., Carrasquilla, J. et al. A framework for demonstrating practical quantum advantage: comparing quantum against classical generative models. Commun Phys 7, 68 (2024).

The combination of steps 510 and 520, executed with a quantum computer, with remaining steps of method 500, enables finding a solution to a continuous optimization problem using comparatively fewer function evaluations. The generative model and configuration pools produced and/or trained in steps 510 and 520 allows a more intelligent (e.g., efficient) exploration of solution space [symbol] the landscape such that solver 400 does not spend valuable cost function evaluations using a local optimizer such as gradient descent.

Step 530 includes generating a refined configuration-pool that includes qualified candidates, of the plurality of the candidate solutions, using a refinement method and candidate solutions of a previous configuration-pool generated using the generative model. Configuration-pool [symbol] ₜ₊₁ of sections 2.2 and 2.3 is an example of the refined configuration-pool of step 530. Each of configuration-pool [symbol] ₜ and a previously-refined configuration pool [symbol] ₜ is an example of the previous configuration-pool. The refinement method may include one of a local search method, a gradient descent method, a simulated annealing method, evolutionary algorithm based method, or a combination thereof.

In an example of step 530, selector 426 generates refined configuration pool 446. Refined configuration pool 446 includes (i) evaluated candidate solutions 446E, which are a subset of evaluated candidate solutions 443E and (ii) non-evaluated candidate solutions 446N, which are a subset of non-evaluated candidate solutions 443N of configuration pool 442.

In embodiments, the refined configuration-pool includes qualified candidates, of the plurality of the candidate solutions, that are at least a predetermined distance from each candidate solution of the previous configuration-pool. Distance r of equation (5) is an example of the predetermined distance. In this refinement method, when generating the refined configuration-pool, the refined configuration-pool may exclude qualified candidates that are candidate solutions, of the plurality of the candidate solutions, that are less than the predetermined distance from each of candidate solution of the previous configuration-pool. Step 530 may include step 534. Step 534 includes repeating step 530 (generating the refined configuration-pool) with a reduced predetermined distance that is less than the predetermined distance. Selector 426 may execute step 534.

Step 540 includes determining, from the evaluated candidate solutions of the qualified candidates, a best candidate solution that yields the lowest cost. In an example of step 540, comparator 428 determines, from evaluated candidate solutions 446E, a best candidate solution 448 that minimizes cost function 414.

Step 560 includes generating a plurality of new cost values by evaluating the cost function of selected non-evaluated candidate solutions of the plurality of candidate solutions. The plurality of new cost values further includes cost values of selected evaluated candidate solutions of the plurality of candidate solutions. In an example of step 560, evaluator 432 generates cost values 453 by evaluating cost function 414 of selected non-evaluated candidate solutions 452N of non-evaluated candidate solutions 443N. Cost values 453 also include cost values 444 of selected evaluated candidate solutions 452E of evaluated candidate solutions 443E.

Step 580 includes, when a new cost value of the plurality of new cost values is less than the cost value of the best candidate solution, replacing the best candidate solution with the selected evaluated candidate solution that yields the new cost value. In an example of step 580, comparator 434 compares the cost value of best candidate solution 448 to cost values 453. When a new cost value of cost values 453 is less than cost value of updated best candidate solution 448, comparator replaces updated best candidate solution 448 with the selected evaluated candidate solution 452E that yields this new cost value.

Method 500 may include a step 505. Step 505 includes replacing the configurations of the input configuration pool with the configurations of the refined configuration pool. In an example of step 505, software 420 replaces the configurations of input configuration pool 411, for a given time step, with evaluated candidate solutions 446E and non-evaluated candidate solutions 446N of refined configuration pool 446 at the same given time step. Solver 400 may then repeat execution of method 500.

Method 500 may also include step 550. Step 550 includes determining (i) a far-configuration pool that includes a number N_{f} of qualified candidates that are most distant from the best candidate solution and (ii) a close-configuration pool that includes a number N_{c} of qualified candidates that are most proximate to the best candidate solution. Configuration pools

$${\overline{ℙ}}_{t + 1}^{f} and {\overline{ℙ}}_{t + 1}^{c}$$

of section 2.2.1 and 2.3 are respective examples of the far-configuration pool and the close-configuration pool.

In an example of step 550 software 420, e.g., comparator 428, determines a far-configuration pool 450F and a close-configuration pool 450C. Far-configuration pool 450F includes N_{f} of qualified candidates, of evaluated candidate solutions 446E and non-evaluated candidate solutions 446N, that are most distant from updated best candidate solution 448. Close-configuration pool 450C includes N_{c} of qualified candidates, of evaluated candidate solutions 446E and non-evaluated candidate solutions 446N, that are most proximate to updated best candidate solution 448.

Step 560 introduces the selected non-evaluated candidate solutions and the selected evaluated candidate solutions. When method 500 includes step 550, the selected non-evaluated candidate solutions (e.g., solutions 452N) includes (a) each non-evaluated qualified candidate of the far-configuration pool (e.g., pool 450F) and (b) each non-evaluated qualified candidate of the close-configuration pool (e.g., pool 450C). Similarly, when method 500 includes step 550, the selected evaluated candidate solutions (e.g., solutions 452E) includes (a) each evaluated qualified candidate of the far-configuration pool and (b) each evaluated qualified candidate of the close-configuration pool.

In embodiments, the size of the refined configuration-pool is less than a predetermined threshold. For example, the size may be less than (N_{f}+N_{c}), where (N_{f}+N_{c}) is the predetermined threshold. Here, the size is the number of qualified candidates in the refined configuration-pool. In such embodiments (whether or not method 500 includes step 550), step 530 may include step 532. Step 532 includes adding additional candidates to the refined configuration-pool such that the size of the refined configuration-pool equals or exceeds the predetermined threshold. The additional candidates may be uniformly distributed in a solution space of the cost function (e.g., cost function 414). The additional candidates may be selected from candidate solutions 443. After executing step 532, method 500 may repeat step 530 to generate refined configuration-pool.

When method 500 includes step 550, it may also include step 590. Step 590 includes randomly removing, from the refined configuration-pool (e.g., pool 446), a number of qualified candidates equal to the lesser of (i) the sum of the number N_{f} and the number N_{c} and (ii) the number of non-evaluated candidate solutions of the refined configuration-pool, to yield a pruned configuration pool. In such embodiments, step 505 includes generating training data set [symbol] ₜ₊₁ using the pruned configuration pool output in step 590. Training data set [symbol] ₜ₊₁ is an example of training data set 441 for a second of subsequent iteration of method 500. Software 420, e.g., selector 426, may execute step 590.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

Any reference herein to the state |0 [symbol] may alternatively refer to the state |1 [symbol] , and vice versa. In other words, any role described herein for the states |0 [symbol] and |1 [symbol] may be reversed within embodiments of the present invention. More generally, any computational basis state disclosed herein may be replaced with any suitable reference state within embodiments of the present invention.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may require thousands or millions of cost function evaluations to generate an improved result; no human could perform so many evaluations even in their lifetime.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found In a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

We claim:

1. A method for solving a continuous optimization problem, comprising:
training a generative model using a training data set [symbol] ₜ;
generating, using the generative model, a configuration-pool [symbol] ₜ₊₁ including a plurality of candidate solutions for minimizing the optimization problem's cost function, the plurality of candidate solutions including both (a) evaluated candidate solutions and (b) non-evaluated candidate solutions, the cost value of the cost function of each evaluated candidate solution being stored in a memory accessible by a device executing the method;
generating a refined configuration-pool [symbol] ₜ₊₁ that includes qualified candidates, of the plurality of the candidate solutions, using a refinement method and candidate solutions of a previous configuration-pool [symbol] ₜ generated using the generative model;
determining, from the evaluated candidate solutions of the qualified candidates, a best candidate solution that yields the lowest cost;
generating a plurality of new cost values by evaluating the cost function of selected non-evaluated candidate solutions of the plurality of candidate solutions; and
when a new cost value of the plurality of new cost values is less than the cost value of the best candidate solution, replacing the best candidate solution with the selected evaluated candidate solution that yields the new cost value.

2. The method of claim 1, further comprising:
generating the training data set [symbol] ₜ using an input configuration-pool [symbol] ₜ generated by the generative model.

3. The method of claim 2, further comprising, after replacing the best candidate solution,
generating an updated training data set [symbol] ₜ₊₁ using the refined configuration-pool [symbol] ₜ₊₁; and
repeating the steps of claim 1, where the training data set [symbol] ₜ₊₁ replaces the training data set [symbol] ₜ.

4. The method of claim 1, further comprising:
determining (i) a far-configuration pool
$${\overline{ℙ}}_{t + 1}^{f}$$
that includes a number N_{f} of qualified candidates that are most distant from the best candidate solution and (ii) a close-configuration pool
$${\overline{ℙ}}_{t + 1}^{c}$$
that includes a number N_{c} of qualified candidates that are most proximate to the best candidate solution;
wherein, in the step of generating the plurality of new cost values,
(i) the selected non-evaluated candidate solutions includes (a) each non-evaluated qualified candidate of the far-configuration pool
$${\overline{ℙ}}_{t + 1}^{f}$$
and (b) each non-evaluated qualified candidate of the close-configuration pool
$${\overline{ℙ}}_{t + 1}^{c} ,$$
(ii) the selected evaluated candidate solutions includes (a) each evaluated qualified candidate of the far-configuration pool
$${\overline{ℙ}}_{t + 1}^{f}$$
and (b) each evaluated qualified candidate of the close-configuration pool
$${\overline{ℙ}}_{t + 1}^{c} .$$

5. The method of claim 4, when the size of the refined configuration-pool [symbol] ₜ₊₁ is less than a predetermined threshold {{| [symbol] ₜ₊₁|<N_{f}+N_{c}}}, where the size is the number of qualified candidates in the refined configuration-pool [symbol] ₜ₊₁, further comprising, before determining the best candidate solution:
adding additional candidates to the refined configuration-pool [symbol] ₜ₊₁ such that the size of the refined configuration-pool [symbol] ₜ₊₁ equals or exceeds the predetermined threshold, the additional candidates being uniformly distributed in a solution space of the cost function; and
repeating the step of generating the refined configuration-pool [symbol] ₜ₊₁.

6. The method of claim 4, further comprising:
randomly removing, from the refined configuration-pool [symbol] ₜ₊₁, a number of qualified candidates equal to the lesser of (i) the sum of the number N_{f} and the number N_{c} and (ii) the number of non-evaluated candidate solutions of the refined configuration-pool [symbol] ₜ₊₁, to yield a pruned configuration pool;
generating a training data set [symbol] ₜ₊₁ using the pruned configuration pool; and
repeating the steps of claim 1, where the training data set [symbol] ₜ₊₁ replaces the training data set [symbol] ₜ.

7. The method of claim 1, in said step of generating the refined configuration-pool [symbol] ₜ₊₁, the refined configuration-pool [symbol] ₜ₊₁ including qualified candidates, of the plurality of the candidate solutions, that are at least a predetermined distance away from each candidate solution of the previous configuration-pool [symbol] ₜ.

8. The method of claim 7, further comprising:
repeating the step of generating the refined configuration-pool [symbol] ₜ₊₁ with a reduced predetermined distance that is less than the predetermined distance.

9. The method of claim 7, when generating the refined configuration-pool [symbol] ₜ₊₁, the refined configuration-pool [symbol] ₜ₊₁ excluding qualified candidates that are candidate solutions, of the plurality of the candidate solutions, that are less than the predetermined distance away from each of candidate solution of the previous configuration-pool [symbol] ₜ.

10. The method of claim 1, in said step of generating the refined configuration-pool [symbol] ₜ₊₁, the refinement method including one of a local search method, a gradient descent method, a simulated annealing method, evolutionary algorithm based method, or a combination thereof.

11. The method of claim 1, training the generative model comprising:
computing a weighted loss function that includes a sum of, for each of a plurality of initial candidate solutions for minimizing the cost function, products of a probability density function and a loss function evaluated at the initial candidate solution, where the cost function is an argument of the probability density function.

12. The method of claim 1, generating the configuration-pool [symbol] ₜ₊₁ comprising filtering out configurations that do not satisfy a predetermined constraint.

13. The method of claim 1, wherein the plurality of new cost values further includes cost values of selected evaluated candidate solutions {{452E}} of the plurality of candidate solutions.

14. A continuous-optimization-problem solver comprising:
a processor; and
a memory storing machine-readable instructions that, when executed by the processor, control the processor to execute the method of claim 1.

15. The solver of claim 14, the processor including a quantum processor.

16. The solver of claim 15, the quantum processor being an annealing quantum processor.

17. The solver of claim 14, the memory further storing machine-readable instructions that, when executed by the processor, control the processor to execute the method of claim 4.

18. The solver of claim 17, the memory further storing machine-readable instructions that, when executed by the processor, control the processor to execute the method of claim 6.

19. The solver of claim 14, the memory further storing machine-readable instructions that, when executed by the processor, control the processor to execute the method of claim 7.

20. The solver of claim 14, the memory further storing machine-readable instructions that, when executed by the processor, control the processor to execute the method of claim 9.

21. The solver of claim 14, the memory further storing machine-readable instructions that, when executed by the processor, control the processor to execute the method of claim 11.

22. The solver of claim 14, wherein the plurality of new cost values further including cost values of selected evaluated candidate solutions of the plurality of candidate solutions.
